(19) United States
(12) Patent Application Publication
(10) Pub. No.: US 2021/0076551 A1
(43) Pub. Date: Mar. 18, 2021

(54) Hand Tool for Removing Loose Dirt from a Hole in the Ground

(71) Applicant: Arthur Leslie Berger, Tallahassee, FL (US)

(72) Inventor: Arthur Leslie Berger, Tallahassee, FL (US)

(21) Appl. No.: 16/571,094

(22) Filed: Sep. 14, 2019

(51) Int. Cl. A01B 1/02; E02F 3/02

(52) U.S. Cl. CPC A01B 1/02; E02F 3/02

(57) ABSTRACT

A hand tool that provides a means for a person standing outside of a hole in the ground to remove loose soil from the bottom of the hole by using, in the preferred embodiments, a shaft to pull the tip of the hand tool across the bottom of the hole and toward the user, and where the loose soil is collected through the open side of the hand tool and onto a horizontal surface where it is contained on said horizontal surface by its sides. Once the loose soil is collected onto the horizontal surface, the shaft is used to lift the loose soil out of the hole for deposit at a location outside of the hole. The hand tool is sized to allow a manageable amount of loose soil to be lifted by hand from the hole. Other embodiments are described.

### CROSS-REFERENCE TO RELATED APPLICATIONS

This application claims the benefit of provisional patent application Ser. No. 62/839,655, filed on 2019 Apr. 27 by the present inventor.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURE BY THE INVENTOR OR A JOINT INVENTOR

Not Applicable.

### BACKGROUND OF THE INVENTION

### (1) Field of the Invention

This invention relates to hand tools. To be more specific, this invention pertains to a tool for removing loose soil from a hole in the ground.

### (2) Description of Related Art Including Information Disclosed Under 37 CFR 1.97 and 1.98

No known prior art.

### SUMMARY OF THE INVENTION

There are many situations where the objective is to dig a relatively small hole in the ground and the use of motorized equipment to excavate the hole is either too costly, unavailable, or otherwise not appropriate. For example, most trees planted by homeowners arrive in containers ranging in size between 7 gallons and 45 gallons, and require a hole having a 3 to 6-foot wide diameter and depth of between 2 to 4 feet. The use of a backhoe to dig such a hole may: (a) be too expensive given an average daily backhoe rental fee of between $100 to $200 per day; (b) be unreasonable because the hole is inaccessible to the backhoe; or (c) cause unwanted damage to nearby permanent improvements such as sidewalks or landscaping. These same concerns apply to situations where utility lines need to be located or relocated in developed areas. The use of motorized equipment, such as a backhoe, may cause damage to adjacent utility lines, fiber optic cables, sidewalks, and traffic control devices. Another significant problem is that once a hole having a 3 to 6-foot wide diameter exceeds approximately 18 inches in depth, it becomes increasingly difficult to remove the loose soil from the bottom of the hole using a shovel. If the person attempting to remove the loose soil from the hole is standing outside but close to the edge of the hole, it is difficult to use a shovel to scoop the loose dirt from the hole because the rim or edge of the hole limits maneuverability of the shovel. Specifically, it becomes difficult to push the shovel forward at a low angle with the ground to collect the loose soil onto the blade of the shovel. If the person standing outside the hole is forced to bend down to push the shovel forward against resistance, the risk of physical injury to the person increases. Similarly, if the person is standing inside the hole, holes having a diameter of 5 feet or less do not offer sufficient space to push the shovel forward at a low angle with the ground to collect the loose soil onto the blade of the shovel. In addition, for a person standing inside the hole, as the hole gets deeper, it becomes increasingly difficult to accurately place the loose soil in a pile at a specific location outside the hole and away from the edge of the hole because the shovel, loaded with the soil, needs to be lifted higher than usual and more or less parallel with the ground to place the soil on top of the pile which is increasing in height as more soil is deposited on it.

An advantage of one or more aspects of the hand tool is that it provides a means which allows the user to stand outside the hole and efficiently lift loose soil from the bottom of the hole for deposit at a specific location outside of the hole. Instead of having to push the blade of a shovel forward, away from the user, at a low angle to the ground to collect the loose soil onto the blade of a shovel, the user of this hand tool drags the tip of the hand tool across the bottom of the hole and toward the user resulting in the loose soil being collected between the sides of the hand tool. Another advantage of one or more aspects of the hand tool is user safety is enhanced because: (a) the number of times the user has to get into and out of the hole is reduced, and (b) less bending is required to collect the loose soil onto the horizontal surface of the hand tool as compared to the use of a shovel. Therefore, unlike a shovel which is pushed or directed away from the user, the hand tool is pulled toward the user.

The hand tool differs from a garden hoe which is designed to break up dirt on the surface of the ground including weeding. A garden hoe is also designed to be small enough to remove weeds from between the plants being cultivated, and does not use or require sides to contain or lift the soil from one location to another. Unlike a garden hoe, this hand tool provides a means to efficiently lift loose soil out of a hole. The sides of the hand tool keep the loose soil from falling back into the hole, and facilitates the placement of the loose soil at a specific deposit location away from the hole. The hand tool that is the subject of this application is sized to provide a means to efficiently move the loose soil out of the hole without exceeding a weight that would tax the lifting ability of an average user.

Accordingly, several advantages of one or more aspects of the hand tool are as follows:

(a) the user of the hand tool can stand outside the hole thus reducing both the physical effort required to dig the hole, and the risk of physical injury associated with repeatedly getting into and out of the hole.

(b) the hand tool is easily pulled toward the user unlike a shovel which must be awkwardly pushed away from the user at a sufficiently low angle with the ground to gather the loose soil onto the blade of the shovel.

(c) bending by the user of the hand tool and the associated risk of physical injury are reduced because the hand tool is typically used in a standing or near standing position, and the act of bending over to push the blade of a shovel away from the user is avoided.

(d) unlike a garden hoe, which is designed as a means for working with soil on the surface of the ground and does not have sides, the hand tool has sides which contain the soil on its horizontal surface, and thereby provides an effective means to lift loose soil out of a hole for deposit away from the edge of the hole.

(e) the above advantages permit the hand tool to complete the task in less time and with less physical effort as compared to other available hand tools.

### BRIEF DESCRIPTION OF THE SEVERAL VIEWS OF THE DRAWINGS

FIG. 1 is a perspective view of the hand tool.

FIG. 2 is a side view of the left side of the hand tool showing the socket and handle attached to the rear side of the hand tool.

FIG. 3 is a cross-section through a hole in the ground showing how the hand tool is intended to be used.

FIG. 4 is a side view of the left side of the hand tool showing an embodiment with the socket and handle attached to the left and right sides of the hand tool.

FIG. 5 is a front view of the hand tool showing an embodiment with the socket and handle attached to the left and right sides of the hand tool.

FIG. 6 is a side view of the hand tool showing an embodiment with perforations in the side of the hand tool.

### DRAWINGS—REFERENCE NUMERALS

10 right side of the hand tool
11 horizontal surface of the hand tool
12 tip of the horizontal surface
13 left side of the hand tool
14 rear side of the hand tool
15 socket
16 shaft or handle
17 predetermined angle between socket and horizontal surface
18 open side of the hand tool
19 attachment connecting the socket to the left and right sides of the hand tool
20 perforations in the side of the hand tool

### DETAILED DESCRIPTION OF THE INVENTION

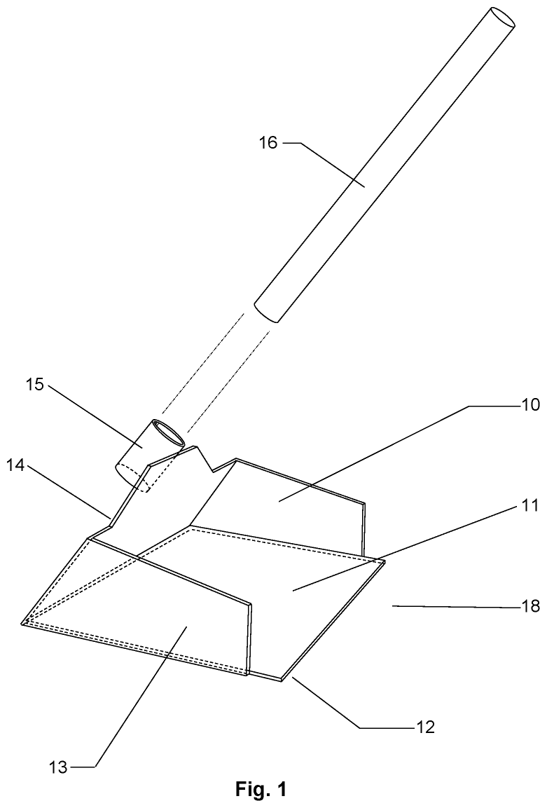

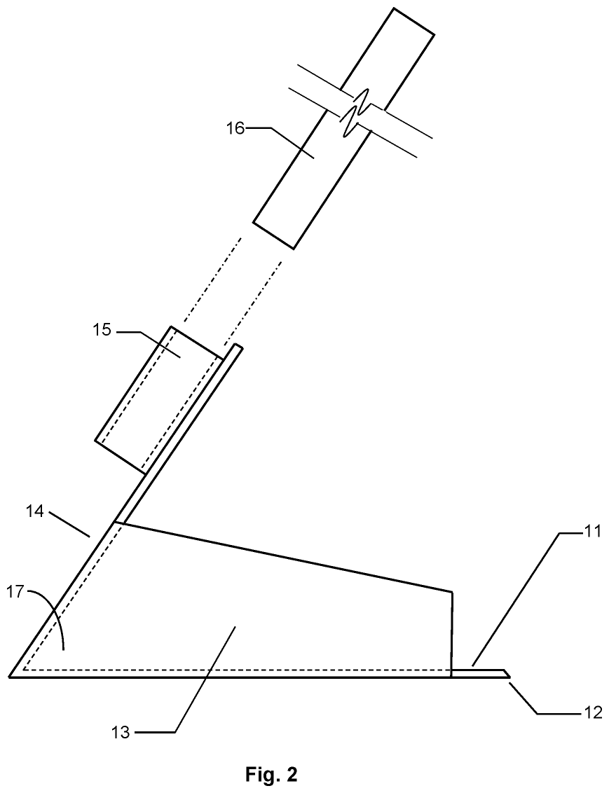

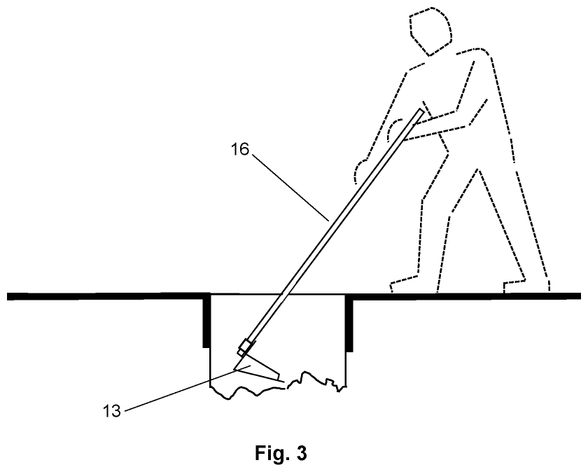

One embodiment is illustrated in FIG. 1 (perspective) and FIG. 2 (side view). The user of the hand tool stands outside the hole and close to the edge of the hole being dug as, for example, shown in FIG. 3. While holding the shaft (16), the user drags the tip (12) of the hand tool across the bottom of the hole and toward the user. Loose soil is collected onto the horizontal surface (11) of the hand tool and is contained on the horizontal surface (11) by its left (13), right (10), and rear (14) sides. The hand tool includes a socket (15) which facilitates connection of the shaft (16) to the hand tool. The angle (17) between the shaft (16) of the hand tool and the horizontal surface (11) of the hand tool is predetermined to permit the user of the hand tool to drag the tip (12) of the hand tool across the bottom of the hole so the loose soil can be collected through the open side (18) of the hand tool and onto the horizontal surface (11) of the hand tool. The preferred range of the predetermined angle is between 30 and 85 degrees and an even more preferred range is between 40 and 60 degrees. The hand tool is sized to allow a manageable amount of loose soil to be lifted by hand from the hole and deposited outside the hole without exceeding a weight that would tax the lifting ability of an average user.

The hand tool can also be fabricated in more than one size. For example, for wide holes, the width of the hand tool from left side to right side can have a preferred width of between 5 and 10 inches, while the width of the hand tool for a narrow linear hole can have a preferred width of between 3 to 8 inches. The hand tool can be manufactured from any rigid material including metal, fiberglass, carbon composites, or plastic with the thickness or gauge of the material varying according to what is required to provide adequate strength and durability. Depending upon the material used to fabricate the hand tool, the preferred range of thickness of the material is between 0.0469 inch and 0.250 inch, and an even more preferred range is between 0.0625 inch and 0.1875 inch.

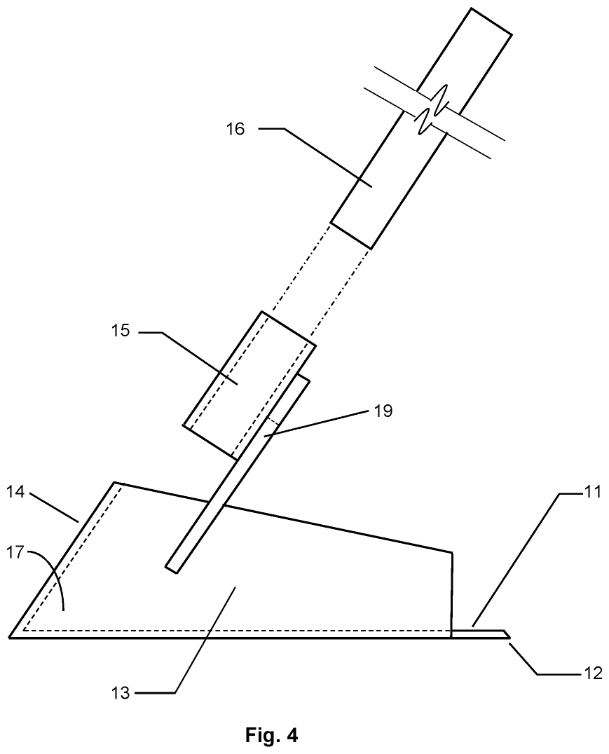

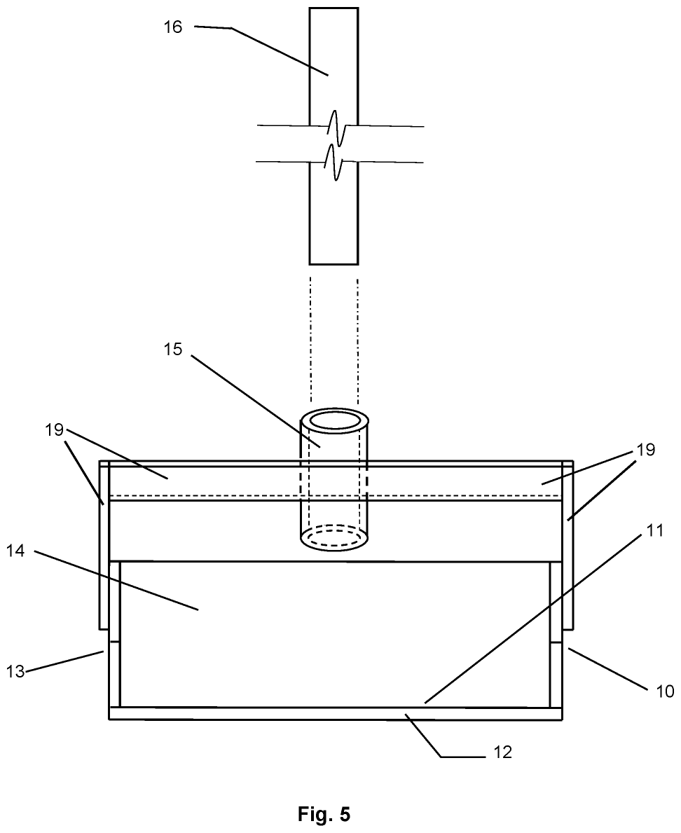

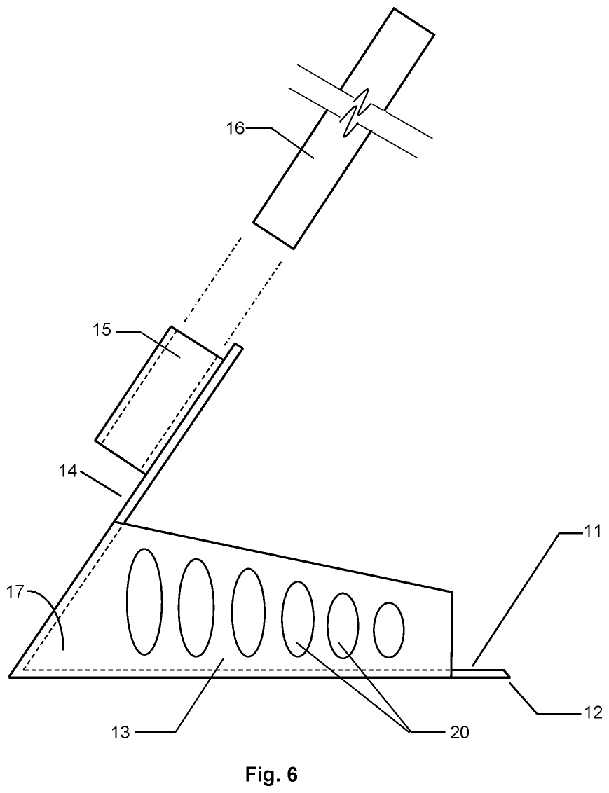

Another embodiment of the hand tool is illustrated in FIG. 4 (side view) and FIG. 5 (front view). In this embodiment, the socket is attached to the left and right sides of the hand tool. FIG. 6 illustrates another embodiment of the hand tool with one or more sides perforated. The perforations, which could vary in number, size, and configuration, would reduce the weight of the hand tool.

Although the description above contains many specificities, these should not be construed as limiting the scope of the embodiments but as merely providing illustrations of some of several embodiments. For example, the horizontal surface (11) and sides of the hand tool can have other shapes and dimensions, and can be stamped, bent, welded, forged, or molded out of one or more pieces of rigid material. Also, there are alternative ways the socket (15) can be attached to the hand tool, and alternative ways to connect the shaft (16) to the socket.

Thus, in addition to the above description, the scope of the embodiments should also include the appended claims and their legal equivalents.

The invention claimed is:

1. A hand tool providing a means for removing loose soil from the bottom of a hole in the ground, comprising:
(a) a horizontal surface fabricated from a rigid material of a predetermined size and thickness onto which loose soil can be collected,
(b) three sides composed of a rigid material of a predetermined size and thickness to contain the loose soil within the limits of the horizontal surface,
(c) the three sides being joined to the horizontal surface leaving one side open for the loose soil to be collected onto the horizontal surface and between the sides of the hand tool,
(d) a socket composed of a rigid material of a predetermined size, thickness, and shape attached to the rear side of the hand tool,
(e) the socket oriented to permit the attachment of a shaft or handle,
(f) the socket of the hand tool having a predetermined angle to the horizontal surface that allows the tip of the hand tool to be dragged across the bottom of the hole while collecting loose soil onto the horizontal surface,
whereby a person standing outside of the hole can grasp the shaft of the hand tool and pull the open side of the tool towards the person thereby collecting loose soil through the open side of the tool and onto the rigid horizontal surface, and the hand tool, with the loose soil contained within its three sides, can be lifted out of the hole by the user and deposited at a location outside the hole.

2. The hand tool provided in claim 1 wherein the socket is attached to the right and left sides of the hand tool.

3. The hand tool provided in claim 2 wherein there is no rear side.

4. The hand tool provided in claim 1 wherein the socket is attached to the horizontal surface.

5. The hand tool provided in claim 4 wherein there is no rear side.

6. The hand tool provided in claim 1 wherein the tip of the hand tool has a beveled edge.

7. The hand tool provided in claim 1 wherein the rear side is attached to the left and right sides but is not attached to the horizontal surface.

8. The hand tool provided in claim 1 wherein the rigid material is composed of metal.

9. The hand tool provided in claim 1 wherein the rigid material is selected from the group consisting of fiberglass, plastic, and carbon composite.

10. The hand tool provided in claim 1 wherein one or more sides of the hand tool is perforated.

11. The hand tool provided in claim 1 wherein the horizontal surface, sides, and socket are formed by weldment.

12. The hand tool provided in claim 1 wherein the horizontal surface, sides, and socket are formed by stamping.

13. The hand tool provided in claim 1 wherein the horizontal surface, sides, and socket are formed by bending.

14. The hand tool provided in claim 1 wherein the horizontal surface, sides, and socket are formed by casting.

15. The hand tool provided in claim 1 wherein the horizontal surface, sides, and socket are formed by moulding.

16. The hand tool provided in claim 1 wherein the horizontal surface, sides, and socket are formed by 3D printing.
